(19) United States
(12) Patent Application Publication
(10) Pub. No.: US 2023/0235213 A1
(43) Pub. Date: Jul. 27, 2023

(54) NEW SYNERGIC COMPOSITION FOR SCALE INHIBITION

(71) Applicant: ITALMATCH CHEMICALS S.P.A., Arese MI (IT)

(72) Inventors: Davide PARRAVICINI, Orsenigo CO (IT); Daniele ZAMBOLIN, Galliate NO (IT); Frédéric BRUYNEEL, Concorezzo MB (IT)

(21) Appl. No.: 17/918,995

(22) PCT Filed: Apr. 17, 2020
(86) PCT No.: PCT/IB2020/053652

§ 371 Date: Oct. 14, 2022

(51) Int. Cl. C09K 8/528; C02F 5/10

(52) U.S. Cl. CPC C09K 8/528; C02F 5/10

(57) ABSTRACT

The invention relates to a synergic scale inhibitor composition advantageously used for preventing scale formation and/or scale deposition in aqueous systems comprising dissolved iron ions, particularly in geothermal field, IWT (Industrial Water Treatment) and oil & gas field.

### BACKGROUND OF THE INVENTION

Scale is a common term in the oil industry, generally used to describe solid deposits that grow over time, blocking and hindering fluid flow through pipelines, valves, pumps etc. with significant reduction in production rates and equipment damages. Oilfield scale inhibition is the process of preventing the formation of scale from blocking or hindering fluid flow through pipelines, valves, and pumps used for example in oil production and processing. Scale inhibitors are a class of compounds that are used to slow or prevent scaling in water systems. Oilfield scaling is the precipitation and accumulation of insoluble crystals (salts) from a mixture of incompatible aqueous phases in oil processing systems. Scale is a common term in the oil industry, used to describe solid deposits that grow over time, blocking and hindering fluid flow through pipelines, valves, pumps etc. with significant reduction in production rates and equipment damages. Scaling represents a major challenge for flow assurance in the oil and gas industry. Examples of oilfield scales are calcium carbonate, iron sulfides, barium sulfate and strontium sulfate. Scale inhibition encompasses the processes or techniques employed to treat scaling problems. Scale build-up effectively decreases pipeline diameter and reduces flow rate. The three prevailing water-related problems that upset oil companies nowadays are corrosion, gas hydrates and scaling in production systems. The reservoir water has a high composition of dissolved minerals equilibrated over millions of years at constant physicochemical conditions. As the reservoir fluids are pumped from the ground, changes in temperature, pressure and chemical composition shift the equilibria and cause precipitation and deposition of sparingly soluble salts that build up over time with the potential of blocking vital assets in the oil production setups. Scaling can occur at all stages of oil/gas production systems (upstream, midstream and downstream) and causes blockages of well-bore perforations, casing, pipelines, pumps, valves etc. Severe scaling issues have been reported in certain North Sea production systems.

Two main classifications of scales are known; inorganic and organic scales and the two types are mutually inclusive, occurring simultaneously in the same system, referred to as mixed scale. Mixed scales may result in highly complex structured scales that are difficult to treat. Such scales require aggressive, severe and sometimes costly remediation techniques. Paraffin wax, asphaltenes and gas hydrates are the most often encountered organic scales in the oil industry, while the simplest and common form of scales are inorganic scales.

Inorganic scales refer to mineral deposits that occur when the formation water mixes with different brines such as injection water. The mixing changes causes reaction between incompatible ions and changes the thermodynamic and equilibrium state of the reservoir fluids. Supersaturation and subsequent deposition of the inorganic salts occur. The most common types of inorganic scales known to the oil/gas industry are carbonates and sulfates but also sulfides and chlorites are often encountered.

While, the solubility of most inorganic salts (NaCl, KCl, . . . ) increases with temperature (endothermic dissolution reaction), some inorganic salts such as calcium carbonate and calcium sulfate have also a retrograde solubility, i.e., their solubility decreases with temperature. In the case of calcium carbonate, it is due to the degassing of CO₂ whose solubility decreases with temperature as it is the case for most of the gases (exothermic dissolution reaction in water). In the case of calcium sulfate, the reason is that the dissolution reaction of calcium sulfate itself is exothermic and therefore is favoured when the temperature decreases. In other terms, the solubility of calcium carbonate and calcium sulfate increases at low temperature and decreases at high temperature, as it is also the case for calcium hydroxide.

After years of oil production, wells may experience significant pressure drops resulting in large CaCO₃ deposits.

Severe problems with sulfate scale are common in reservoirs where seawater has been injected to enhance oil recovery.

The scaling-tendency of an oil-well can be predicted based on the prevailing conditions such as, for example, pH, temperature, pressure, ionic strength.

Different oilfield scale remediation techniques, such as sulfate ion sequestering from sea injection waters, chemical or mechanical Scale removal/dissolution and application of Scale Inhibitors (SIs) for scale prevention are known.

The first two methods may be used for short-term treatment and effective for mild-scaling conditions, however, continuous injection or chemical scale squeeze treatment with scale inhibitors have been proven over the years to be the most efficient and cost-effective preventative technique.

Scale inhibitors are chemical compounds that are added to oil production systems to delay, reduce and/or prevent scale deposition. Acrylic acid polymers, maleic acid polymers and phosphonates have been used extensively for scale treatment in water systems due to their excellent solubility, thermal stability and dosage efficiency. In the water treatment industry, the major classes of scale inhibitors are characterized by inorganic phosphate, organophosphorous and organic polymer backbones and common examples are PBTC (phosphonobutane-1,2,4-tricarboxylic acid), ATMP (amino-trimethylene phosphonic acid) and HEDP (1-hydroxyethylidene-1,1-diphosphonic acid), polyacrylic acid (PAA), phosphinopolyacrylates (such as PPCA), polymaleic acids (PMA), maleic acid terpolymers (MAT), sulfonic acid copolymers, such as SPOCA (sulfonated phosphonocarboxylic acid), polyvinyl sulfonates. Two common oilfield mineral SIs are Poly-Phosphono Carboxylic acid (PPCA) and Diethylenetriamine-penta (methylene phosphonic acid) (DTPMP).

Generally, the environmental impacts of scale inhibitors are complicated further by combination of other compounds applied through exploratory, drilling, well-completion and start-up operations. Produced fluids, and other wastes from oil and gas operations with high content of different toxic compounds are hazardous and harmful to human health, water supplies, marine and freshwater organisms.

Efforts to develop more environmentally friendly scale inhibitors have been made since the late 1990s and an increasing number of such scale inhibitors are becoming commercially available. Recent environmental awareness over the past 15 years has resulted in the production and application of more environmentally friendly scale inhibitors, that were designed to have reduced bio-accumulating and high biodegradability properties and therefore reduce pollution of the waters around oil production systems. Phosphate ester scale inhibitors, commonly employed for treating calcium carbonate scales, are known to be environmentally friendly but are characterized by poor inhibition efficiency. Release of scale inhibitors containing Nitrogen and Phosphorus may distort the natural equilibrium of the immediate water body with adverse effects on aquatic life. Therefore, less amount of scale inhibitors is needed, still maintaining their high efficiency in scale inhibition.

Both phosphonates and polymers, as they are widely used in this type of application, must be dosed in sub-stoichiometric amounts. For example, a typical dosage of these kind of scale inhibitors is in the range from 0.1 ppm up to 100 ppm, depending on the severity of conditions. Anyway, in very critical conditions, the dosage can exceed 100 ppm and reach 1000 ppm or more.

Dosage is usually highly affected by the presence of Fe′ ions, which strongly binds to most of the common scale inhibitors, thus reducing the capability of these compounds to prevent scale deposition.

Recent researches were focused on the development of new scale inhibitors characterized by better performance compared to standard known compounds used as scale inhibitors, in order to reduce the dosage needed to reach satisfactory results in scale inhibition.

### DESCRIPTION OF THE INVENTION

The present invention relates to a synergic scale inhibitor composition comprising Aminoethyl-ethanolamine-tri(methylene phosphonic acid) (abbreviated here below as AEEA phosphonate) and Bis (HexaMethyleneTriaminePenta (methylenephosphonicAcid) (abbreviated here below as BHMTPA phosphonate). AEEA phosphonate has the following chemical formula:

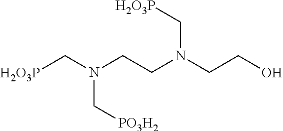

and molecular formula C₇H₂₁O₁₀N₂P₃ (linear form), while

BHMTPA has the following chemical formula:

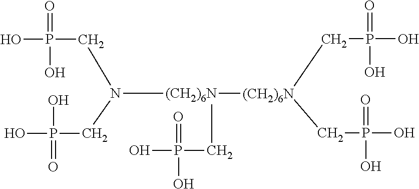

and molecular formula C₁₇H₄₄O₁₅N₃P₅.

The synergic scale inhibitor composition according to the invention is advantageously used for preventing scale formation and/or scale deposition in aqueous systems, particularly in geothermal field, IWT (Industrial Water Treatment) and oil & gas field, more particularly in oilfield. According to the invention, said aqueous systems comprises dissolved iron ions, and said scale is a mixed scale.

AEEA phosphonate and BHMTPA phosphonate act as active ingredients in the composition of the present invention and show an interesting synergic effect. Synergic scale inhibitor composition according to the invention may further comprise polymers and phosphonates, surfactants, corrosion inhibitors, sequestrant and chelating agents, biocides, foam controlling agents, oxygen and H₂S scavengers, pH controlling and buffering agents, organic solvents.

According to the invention, said surfactants are selected among anionic surfactants, non-ionic surfactants, amphoteric surfactants and cationic surfactants and said organic solvents are selected among methanol, glycols and other alcohols.

The synergic scale inhibitor composition according to the present invention is characterized in that BHMTPA ratio ranges from 90 to 10 and AEEA ratio ranges from 10 to 90 respectively, particularly BHMTPA ratio ranges from 60 to 10 and AEEA ratio ranges from 40 to 90 respectively. Preferred ratios are those where BHMTPA ratio ranges from 50 to 20 and AEEA ratio ranges from 50 to 80 respectively. Preferred ratios between the two active ingredients are BHMTPA from 75 to 25 and AEEA from 25 to 75 respectively. For example, preferred ratios are the following:

BHMTPA:AEEA 25:75

BHMTPA:AEEA 50:50

BHMTPA:AEEA 75:25

Particularly preferred ratio is BHMTP:AEEA 25:75.

Ratio are expressed as weight with respect to the total weight of the composition.

The composition of said two active ingredients is able to provide good scale inhibition performances while its scale inhibition action results not affected by the presence of Fe²⁺ ions.

This is a very good result. In fact, the composition according to the invention, due to the synergic scale inhibition action exerts by the two active ingredients AEEA and BHMTPA phosphonates, can be used at a very low dosage, if compared to many of the most efficient known scale inhibitors, still maintaining high efficiency and high levels of scale inhibition activity.

This is particularly true when the scaling risk is due to the formation and/or deposition of both CaCO₃ and BaSO₄.

An additional advantage of the composition according to the invention is related to the fact that Fe²⁺ does not affect the efficacy as scale inhibitor of the composition. For this reason, even smaller amounts of composition can be successfully used, because the totality of the dosed composition can be maintained effective in preventing formation and/or deposition of scales in water systems, particularly in oilfield.

Therefore, the synergic effect of the two active ingredients (AEEA and BHMTPA phosphonates), together with the fact that the presence of ion Fe′ does not affect the scale inhibition activity of the composition, allows to use very low amount of the composition, thus avoiding environmental drawbacks, reducing the cost of the treatments and reducing high maintenance plant costs.

The synergy observed for the two active ingredient in a single composition is a surprising effect. The composition according to the invention exerts its scale inhibition activity in a mixed scale of barium sulphate and calcium carbonate in the presence of iron.

It must be noted that BHMTPA, according to the invention, is used in a scale inhibitor composition for CaCO₃/BaSO₄ mixed scale cases, in the presence of high amount of Fe²⁺. This phosphonate has usually a poor iron tolerance, which leads to bad performance (high MIC) as also confirmed in the tests according to the following experimental part.

The combination of BHMTPA phosphonate and AEEA phosphonate (this latter being characterized by a better iron tolerance with respect to BHMTPA) would have lead, in principle, to worse performance compared to “pure” AEEA phosphonate. However, unexpectedly according to the present invention, it was observed the opposite effect: adding a specific amount of BHMTPA to AEEA phosphonate provides a very significant iron tolerant scale inhibitor composition according to the present invention, characterized by better performance with respect to known scale inhibitors and characterized by lower MIC compared to single raw materials.

Due to the synergy between the two active ingredients, the composition according to the present invention shows better performance compared to single active ingredients. The composition according to the invention is particularly useful to prevent scale formation and/or scale deposition of inorganic compound containing cations such as calcium (Ca), magnesium (Mg), barium (Ba), strontium (Sr), iron (Fe), copper (Cu), zinc (Zn) and manganese (Mn).

The composition exerts its activity of scale inhibition in aqueous systems at a preferred dosage of from 0.5 ppm to 1000 ppm. Particularly preferred is its scale inhibition activity in aqueous systems at a dosage of from 1 ppm to 100 ppm.

The present invention also relates to a process for treating aqueous systems, particularly in oilfield, to prevent scale formation and/or scale deposition of inorganic compound containing cations such as calcium (Ca), magnesium (Mg), barium (Ba), strontium (Sr), iron (Fe), copper (Cu), zinc (Zn) and manganese (Mn).

Typical process conditions include:
Ca²⁺ content lower than 20000 ppm, preferably lower than 10000 ppm, more preferably lower than 5000 ppm
Ba²⁺ content lower than 2000 ppm, preferably lower than 1000 ppm, more preferably lower than 500 ppm
Fe²⁺ content lower than 2000 ppm, preferably lower than 1000 ppm, more preferably lower than 500 ppm
Temperature lower than 200° C., preferably lower than 160° C., more preferably lower than 130° C.
pH between 4 and 10, preferably between 5 and 9, more preferably between 6 and 8.

### EXPERIMENTAL PART

### Experimental Conditions of the Tests

Tube blocking tests (TBT) was used to compare the scale control performance of BHMTPA (Molecule A) and AEEA (Molecule B) phosphonates alone and in combination between each other's, to demonstrate synergic effect. The following ratios have been considered:
[Molecule A: Molecule B]—0:100
[Molecule A: Molecule B]—25:75
[Molecule A: Molecule B]—50:50
[Molecule A: Molecule B]—75:25
[Molecule A: Molecule B]—100:0

CaCO₃/BaSO₄ scale inhibition tests in the presence of Fe²⁺ have been performed by using a Dynamic Scale Rig (Techbox Systems H400) with automatic data recording of differential pressure through a stainless steel coil. The instrument is equipped with two double pistons pumps (Knauer Azura P4.1S), one used for cationic brine and one for anionic “inhibited anionic” brine and the cleaning solutions. The oven (Memmert UF55Plus) set is suitable for temperature up to 300° C. Temperature and pressure tested were respectively 88° C. and 150 psi. Flow rate was 8 mL/min and pH 6.9-7.0. The brine used for the performance tests is described in the following Table 1.

TABLE 1

| Ion | ppm |
|---|---|
| Na⁺ | 6871 |
| K⁺ | 43 |
| Mg²⁺ | 39 |
| Ca²⁺ | 239 |
| Sr²⁺ | 33 |
| Ba²⁺ | 100 |
| Fe²⁺ | 200 |
| Cl⁻ | 6087 |
| SO₄²⁻ | 360 |
| HCO₃⁻ | 1694 |

Testing brine is splitted into Anionic (NaCl and SO₄²⁻ and HCO₃⁻ ions as sodium salts) and Cationic (NaCl and K⁺ Ca²⁺ Mg²⁺ Sr²⁺ Ba²⁺ and Fe²⁺ ions as chloride salts) solutions.

Before adding Fe²⁺, cationic solution is purged with N₂ for about 1 hour in order to remove the dissolved oxygen, which can oxidize Fe²⁺ ions to Fe²⁺ ions. Anionic brine is purged with CO₂ and N₂ in order to remove dissolved oxygen and buffer the pH. Bubbling is maintained during the performance test.

Anionic and cationic brines are pumped separately through two 2-m-long Hastelloy pre-heating coils, and then combined by a union tee in a 1-meter Stainless Steel coil (ID 1 mm). A pressure transducer measures differential pressure between the inlet and outlet of the coil, until it reaches the designed threshold value (2 psi).

After each test, 5% alkaline EDTA solution and DI water are used to clean and restore the coil. In each experiment the time to block the coil is measured in comparison to the time to block of the blank. A successful test is when the pressure drop does not achieve the target threshold after a time equal to 3× “blank time to block”. The standard experiment is designed with a decreasing ramp of dosage, for example 10. 8. 5 and 3 ppm. When a concentration step is not successful—which means that the threshold pressure drop value is achieved—that blocking dosage is considered as “not safe” and the previous higher dosage is called the Minimum Inhibitor Concentration or MIC and defined as the lowest safe dosage for that particular inhibitor and conditions.

Results

Results are expressed as MIC and are summarized in the following Table 2:

TABLE 2
MIC of Molecule A & Molecule B at different ratio

| | | MIC (ppm as |
|---|---|---|
| | | “active solid”) |
| Solution 1 | [Molecule A:Molecule B] - 0:100 | 8 |
| Solution 2 | [Molecule A:Molecule B] - 25:75 | 5 |
| Solution 3 | [Molecule A:Molecule B] - 50:50 | 8 |
| Solution 4 | [Molecule A:Molecule B] - 75:25 | 50 |
| Solution 5 | [Molecule A:Molecule B] - 100:0 | 50 |

The synergic effect can be assessed using the following two different equations Eq.1 and Eq.2:

$$\% Synergy = ( \frac{100 \times ( Min ( {MIC}_{1} ; {MIC}_{2} ) - {MIC}_{3} )}{Min ( {MIC}_{1} ; {MIC}_{2} )} ) \qquad Eq . 1$$

$$\% Synergy = ( \frac{100 \times ( Avg ( {MIC}_{1} ; {MIC}_{2} ) - {MIC}_{3}}{AVG ( {MIC}_{1} ; {MIC}_{2} )} ) \qquad Eq . 2$$

Where:

MIC₁=MIC of Molecule A “as it is” (that means alone)

MIC₂=MIC of Molecule B “as it is” (that means alone)

MIC₃=MIC of Molecule A: Molecule B blend (that means the composition according to the present invention where both A and B are present)

Both above equations have been considered for determining the synergic effect in Solution 2, 3 and 4 (Table 3):

TABLE 3

| Solution | % Synergy - Eq. 1 | % Synergy - Eq. 2 |
|---|---|---|
| [Molecule A:Molecule B] - | +37.5 | +82.8 |
| 25:75 (solution 2) | | |
| [Molecule A:Molecule B] - | 0.0 | +72.4 |
| 50:50 (Solution 3) | | |
| [Molecule A:Molecule B] - | −525.0 | −72.4 |
| 75:25 (Solution 4) | | |

Results Analysis

Table 3 data show synergic activity of BHMTPA phosphonate in combination with AEEA phosphonate.

Considering Eq. 2 for assessing the synergic activity, a positive value is achieved for ratio of 25:75 and 50:50 (solution 2 and solution 3), as the MIC found for these compositions is lower than the average MIC of single raw materials (solution 1 and solution 5).

Considering Eq. 1 for assessing the synergic activity, a positive value is achieved only for ratio of 25:75 (solution 2), as the MIC found for this solution is lower than both the MIC of single raw materials (solution 1 and solution 5).

1. Synergic scale inhibitor composition comprising AminoEthylEthanolAmine phosphonate (AEEA phosphonate) and Bis (HexaMethyleneTriaminePenta (methylenephosphonic) Acid (BHMTPA phosphonate) and/or their suitable salts.

2. Synergic scale inhibitor composition according to claim 1, wherein BHMTPA ratio ranges from 90 to 10 and AEEA ratio ranges from 10 to 90 respectively.

3. Synergic scale inhibitor composition according to claim 2, wherein BHMTPA ratio ranges from 60 to 10 and AEEA ratio ranges from 40 to 90 respectively.

4. Synergic scale inhibitor composition according to claim 3, wherein BHMTPA ratio ranges from 50 to 20 and AEEA ratio ranges from 50 to 80 respectively.

5. Synergic scale inhibitor composition according to claim 2, wherein BHMTPA ratio and AEEA ratio are selected from: BHMTPA:AEEA 25:75, BHMTPA:AEEA 50:50 and BHMTPA:AEEA 75:25.

6. Synergic scale inhibitor composition according to claim 3, wherein BHMTPA ratio and AEEA ratio is BHMTPA:AEEA 25:75.

7. Synergic scale inhibitor composition according to claim 1, exerting its activity of scale inhibition in aqueous systems at a dosage of from 0.5 ppm to 1000 ppm.

8. Synergic scale inhibitor composition according to claim 7, exerting its activity of scale inhibition in aqueous systems at a dosage of from 1 ppm to 100 ppm.

9. Synergic scale inhibitor composition according to claim 1, further comprising polymers and phosphonates, surfactants, corrosion inhibitors, sequestrant and chelating agents, biocides, foam controlling agents, oxygen and H2S scavengers, pH controlling and buffering agents, organic solvents.

10. Synergic scale inhibitor composition according to claim 9, wherein said surfactants are selected among anionic surfactants, non-ionic surfactants, amphoteric surfactants and cationic surfactants and said organic solvents are selected among methanol, glycols and other alcohols.

11. (canceled)

12. The method according to claim 15, wherein said aqueous systems comprises dissolved iron ions.

13. The method according to claim 15, wherein said scale is a mixed scale.

14. (canceled)

15. Process for treating aqueous systems to prevent scale formation and/or scale deposition of inorganic compounds containing cations, comprising the step of treating said aqueous system with the composition according to claim 1.

16. The process according to claim 13, wherein said cations are selected among calcium (Ca), magnesium (Mg), barium (Ba), strontium (Sr), iron (Fe), copper (Cu), zinc (Zn) and manganese (Mn) cations.

17. The process according to claim 15, applied in geothermal field, Industrial Water Treatment (IWT) and oil & gas filed.
